(19) United States
(12) Patent Application Publication
(10) Pub. No.: US 2008/0127472 A1
(43) Pub. Date: Jun. 5, 2008

(54) Universal vehicle tire valve core and cap removal and installation tool

(75) Inventors: Michael L. Whitehead, Clarinda, IA (US); Stanley Lea, Milan, MN (US); Jerry A. Vaught, Lafayette, IN (US); Chancey Woodrick, Groveton, TX (US); Steven Lea, Milan, MN (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 10/848,418

(22) Filed: May 18, 2004

(51) Int. Cl. B25B 27/14; B23P 19/04; B25B 27/24; B60C 25/18

(52) U.S. Cl. 29/221.5

(57) ABSTRACT

Universal vehicle tire valve core and cap removal installation tool includes a cap removal counterbore at one end of a cylindrical rod member and a reversible valve core engagement member positioned in a counterbore at the opposite end of the cylindrical rod member.

### BACKGROUND OF THE INVENTION

In a principal aspect the present invention relates to a tool that may be utilized to remove or replace and install tire valve cores as well as the cap which typically covers a vehicle tire valve.

Auto mechanics and vehicle service technicians often need to replace or repair the tire valve associated with the pneumatic tires of a vehicle. Typically, the tire valves include a spring biased valve core member which is threadably inserted through a valve stem leading to the interior of the pneumatic tire. Typically, the valve stem includes a cap which must be removed in order to provide access to the valve core member.

Valve cores or valve core members may require replacement for numerous reasons. The valve core may have failed for some reason and requires replacement. It may be corroded and not operate properly. In any event, tools for removal and replacement of tire valve cores have been available. Typically, such tools are in the form of a screwdriver type tool and are designed to engage the tire valve core and then effect rotation or unthreading of the valve core from the valve stem. Such tools are designed for utilization with tire valve cores having a uniform or single size. In practice, however, differently sized pneumatic tires may utilize a valve stem and core construction having various sizes, for example.

Thus, there has arisen the need to provide some means by which various sizes of tire valve cores can be easily removed and/or installed from an associated valve stem.

### SUMMARY OF THE INVENTION

Briefly, the present invention comprises a vehicle tire valve core and cap removal tool which enables the user thereof to adjust the tool so as to enable removal of tire valve cores of various sizes. Further, the tool includes a feature which facilitates removal of the valve stem cap, for example, a plastic cap which typically is threadably attached to a valve stem to protect the valve core retained within the stem. Such caps often become corroded or otherwise very difficult to remove from a valve stem. Further, such caps, as well as tire valve cores themselves, may be located on valve stems which are not easily accessible. The tool of the invention provides an improved ability to access such valve stems and their cores as well as to effect removal of a protective cap from such difficult to access valve stems.

Thus, it is an object of the invention to provide a vehicle tire valve core and cap removal and installation tool which enables the user to remove and replace tire valve cores and caps having various sizes and configurations and accessibility.

Further, it is an object of the invention to provide a tire valve core and cap removal and installation tool which is rugged, compact, easy to use and inexpensive.

Yet another object of the invention is to provide a tool for removal of tire valve cores from a valve stem wherein the tire valve core may have a unique size and thus requires utilization of a specialized tool.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an exploded partial cross sectional view of the tool of the invention;

FIG. 2 is a cross sectional view of the tool of the invention;

FIG. 3 is an isometric view of the manner of utilization of the tool of the invention to remove a tire valve core; and

FIG. 4 is an isometric view of the tool of the invention utilized to remove a valve cap from the valve stem.

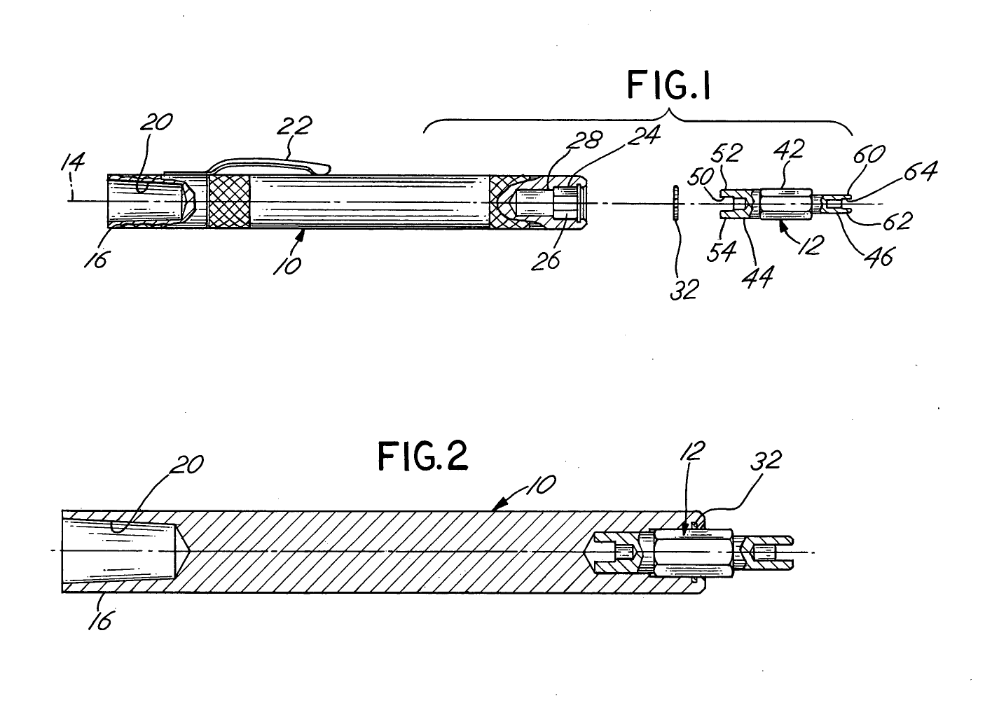

### DESCRIPTION OF THE PREFERRED EMBODIMENT

Referring to the figures, the tool of the invention is comprised of two basic components or parts. A body member 10 is provided in the form of a generally cylindrical, knurled rod as depicted in the figures. The body member 10 cooperates with a tire valve core engagement member 12. These members 10 and 12 interact one with the other to provide universal capability in a single tool for removal and installation of tire valve cores in a valve stem, for example, as typically utilized with tubeless pneumatic motor vehicle tires.

Referring again to the figures, the body member 10 is generally cylindrical and symmetric about a longitudinal axis 14. The body member 10 includes a first or cap engaging end 16 and an opposite or valve core engaging end 18. Referring to the cap engaging end 16, a symmetric counterbore 20 is defined at the cap engaging end 16 which extends inwardly along the longitudinal axis 14 symmetrically about that axis 14. The counterbore 20 has a first greater radius at its outer end adjacent the cap engaging end 16 than the radius of the counterbore as it recedes into the body member 10. Thus, the counterbore 20 typically has a generally frustoconical configuration. The counterbore 20 is designed to function so as to fit and frictionally engage a cap associated with a valve stem of a vehicle tire so that the cap may be engaged and the body member 10 then rotated about the axis 14 to either loosen or tighten the cap and thus remove or place it on a valve stem.

The body member 10 is approximately 3-4 inches in length and typically in the range of approximately ½ inch in diameter. As such, a pocket clip 22 may be positioned on the body member 10 and the tool conveniently stored in the breast pocket of a mechanic or auto repair service person.

The body member 10 further includes at its valve core engaging end 18 a counterbore 24 which typically, as depicted in the figures, comprises a keyed section 26 and a further counterbore section 28. The keyed section 26 will typically have, for example, a hexagonal cross section profile. However, other profiles may be utilized to provide the function of the keyed section which is to retain a valve core engaging member 12 so as to enable rotation thereof when the member 12 (described below) is inserted into the counterbore 24.

The body member 10 further includes an internal slot 30 adjacent the distal end 18 into which a C-shaped retaining ring 32 may be inserted so as to frictionally engage the valve core engaging member 12 described hereinafter.

The valve core engaging or engagement member 12 is designed for reversible insertion into the counterbore 24. The engagement member 12 includes a midsection 42 which has a cross sectional profile substantially congruent with the cross sectional profile of the keyed section 26 of the counterbore 24. Note that the cross sectional profile of the midsection 42 is greater than the profile associated with a first valve engaging element 44 at one end of the engagement member 12 or a second valve core engagement element 46 at the opposite end. The midsection or mid element 42 and the valve core engaging elements 44 and 46 are generally symmetric about the longitudinal axis 14 and are generally straight line elements which extend in the direction of the axis 14.

The valve core engaging end elements 44 and 46 have a generally similar construction, but are of different sizes so as to enable their cooperative engagement with valve cores of differing size. Thus the valve core engaging element 44 includes a counterbore 50 which is coaxial along the axis 14 and further includes bifurcated side wings 52 and 54 which enable the element 44 to fit over the end of a valve core and engage the core in a manner which will permit rotation thereof for threading or unthreading the valve core from a valve stem. The diameter of the element 44 is thus associated with the size of the valve stem and associated valve core.

In a similar fashion, the second core engagement element 46 includes bifurcated wings or arms 60 and 62 which are positioned on opposite sides of the counterbore opening 64. The second core engagement element 46 is thus sized for engagement with a valve core having a unique size and configuration.

The engagement member 12 is designed to slip into the counterbore 24 and be retained by the C-shaped retaining clip or a snap ring 32 retained in the slot 30. Inasmuch as the engagement member 12 is keyed to the body member 10, rotation of the body member 10 will effect rotation of the engagement member 12. Thus, depending upon which element 44 or 46 is projecting longitudinally from the bore 24, the tool is configured so as to be useful with respect to a correspondingly unique valve core. The engagement member 12 may thus be easily removed from the body member 10 and reversed. Alternatively, various sized engagement members may be utilized. That is, different engagement members 12 may have valve core engagement elements 44, 46 which are different from other engagement elements 44, 46 but may still be utilized in combination with the body member 10.

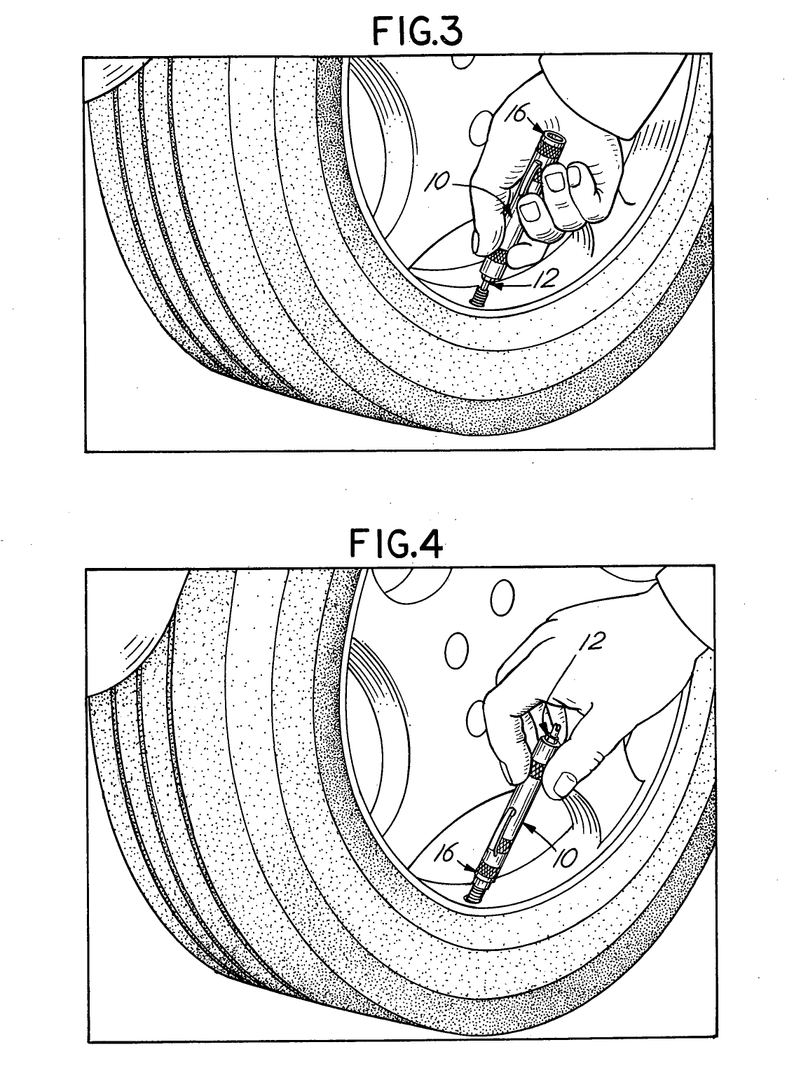

The tool thus enables a mechanic as illustrated in FIGS. 3 and 4 to remove, replace and install various sizes of valve cores associated with valve stems. Additionally, the tool enables ease of removal of caps which protect the outer end of a valve stem. The body member 10 has an adequate length so that the various engaging elements such as the counterbore 20 and the engagement member 12 may be directed and fit into restricted access environments thus enabling the use of the tool for many applications which prior art tools were not immediately useful with respect thereto.

Variations of the tool may be effected without departing from the spirit and scope of the invention. The particular configuration of the counterbores, the valve core engaging elements, the keyed sections of the various elements, the length and diameter of the various elements may all be altered without departing from the spirit and scope of the invention. The invention is therefore to be limited only by the following claims and equivalents thereof.

What is claimed is:

1. A universal vehicle tire valve core and cap removal and installation tool comprising, in combination:
a single body member including a cap engaging end and an opposite valve core engaging end, said cap engaging end including a tapered counterbore having a generally circular cross section with a greater diameter at the cap engaging end transitioned to a lesser diameter toward the opposite valve core end;
an axial bore in the valve core end, said axial bore having, at least in part, a keyed cross sectional configuration; and
a tire valve core engagement member for reversible insertion into the axial bore, said engagement member including a center line axis, a first tire valve engaging element at one end and a second, distinct tire valve engaging element at the opposite end, said engaging elements separated by a middle element having a cross sectional keying configuration compatible with the keyed cross sectional configuration of the axial bore whereby insertion of the core engagement member in the axial bore enables simultaneous rotation of the body member and core engagement member, both said core engagement first and second tire valve engaging elements including a notched outer end and a counterbore extending from the notched end axially toward the middle element, said first and second tire valve engaging elements being uniquely sized, and said core engagement member being reversibly insertable into the axial bore.

2. The tool of claim 1 wherein the cap and counterbore and axial bore are coaxial.

3. The tool of claim 1 wherein the body member is generally cylindrical.

4. The tool of claim 1 wherein the body member has an outside surface which is, at part, knurled.

5. The tool of claim 1 wherein the axial bore has a regular polygonal cross sectional ration.

6. The tool of claim 1 wherein the cross sectional area of the middle element is than the cross sectional area of either valve engaging element.
